(19) United States
(12) Patent Application Publication
(10) Pub. No.: US 2014/0022790 A1
(43) Pub. Date: Jan. 23, 2014

(54) LED LAMP STRUCTURE

(71) Applicant: Yu-Chin WANG, Taipei 114 (TW)

(72) Inventor: Yu-Chin WANG, Taipei 114 (TW)

(73) Assignee: EIKO ELECTRIC PRODUCTS CORP., Taipei 114 (TW)

(21) Appl. No.: 13/552,069

(22) Filed: Jul. 18, 2012

(51) Int. Cl. F21V 15/01

(52) U.S. Cl. 362/249.02

(57) ABSTRACT

A LED lamp structure includes a circuit board carrying multiple spaced LEDs and provided with a power cable, a single-piece housing cut from an integral tubular bar subject to the length of the circuit board and adapted to accommodate the circuit board, two end plugs respectively plugged into the two ends of the single-piece housing, and two end caps respectively capped on the two ends of the single-piece housing for enabling the power cable to extend to the outside of the single-piece housing for connection to an external power source.

### BACKGROUND OF THE INVENTION

1. Field of the Invention

The present invention relates LED lighting technology and more particularly, to a LED lamp structure, which allows the use of same component parts to make different lengths and configurations of LED lamps.

2. Description of the Related Art

In the early days since the creation of semiconductor light source, LEDs can simply give off low-intensity red light. Single-color LEDs were developed a certain period of time after the creation of semiconductor light source. Nowadays, modern designs of LEDs are available across the visible, ultraviolet, and infrared wavelengths, with very high brightness. LEDs are used in applications as aviation lighting, automotive lighting, advertising, general lighting and traffic signals. LEDs prevent many advantages over conventional incandescent light sources, including lower energy consumption, longer lifetime, longer durability, smaller size, and faster switching.

However, for general lighting application, multiple LEDs shall be arranged on the surface of a circuit board, and a housing shall be provided subject to the dimension and length of the circuit board. A specific size of housing simply fits one specific circuit board, i.e., different housings must be prepared to fit different lengths or sizes of LED circuit boards. In consequence, the fabrication of different sizes or configurations of LED lamps will be complicated, increasing the manufacturing cost.

### SUMMARY OF THE INVENTION

The present invention has been accomplished under the circumstances in view. It is main object of the present invention to provide a LED lamp structure, which allows the use of same component parts to make different lengths and configurations of LED lamps.

It is another object of the present invention to provide a LED lamp structure, which saves the manufacturing costs of different lengths of LED lamps.

It is still another object of the present invention to provide a LED lamp structure, which simplifies the manufacturing steps.

It is still another object of the present invention to provide a LED lamp structure, which meets watertight safety rules.

To achieve these and other objects of the present invention, a LED lamp structure comprises a circuit board carrying multiple spaced LEDs and provided with a power cable, a single-piece housing cut from an integral tubular bar subject to the length of the circuit board and defining therein an accommodation chamber for accommodating the circuit board, two end plugs respectively plugged into the two ends of the accommodation chamber of the single-piece housing, and two end caps respectively capped on the two ends of the single-piece housing for enabling the power cable to extend to the outside of the single-piece housing for connection to an external power source.

Further, the single-piece housing comprises two longitudinal locating grooves bilaterally disposed in the accommodation chamber and configured subject to the board thickness of the circuit board for the positioning of the circuit board.

Further, each end plug comprises two opposing side flanges respectively fitting the longitudinal locating grooves of the single-piece housing.

Further, the single-piece housing comprises at least one step located on the outside wall and extending along the length thereof.

Further, each end cap has an inside wall thereof configured to fit the cross section of the opposing front and rear ends of the single-piece housing.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a LED lamp structure in accordance with the present invention.

FIG. 2 is a perspective exploded view of the LED lamp structure in accordance with the present invention.

FIG. 3 is a longitudinal sectional view of the LED lamp structure in accordance with the present invention.

FIG. 4 is a sectional view taken along line A-A of FIG. 3.

### DETAILED DESCRIPTION OF THE PREFERRED EMBODIMENT

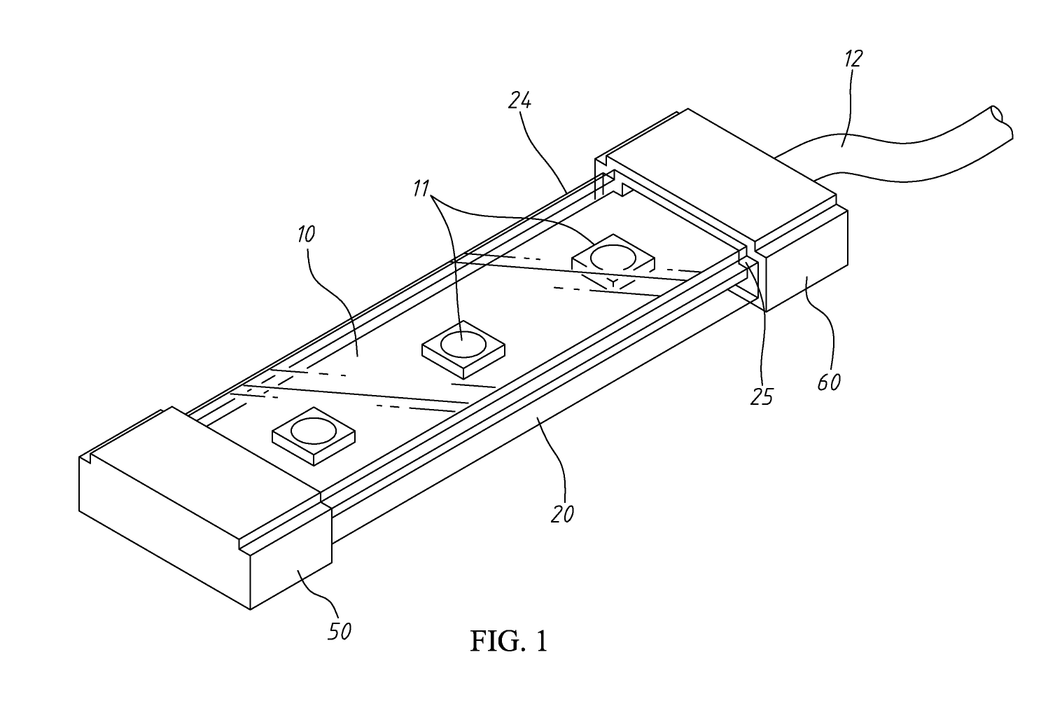

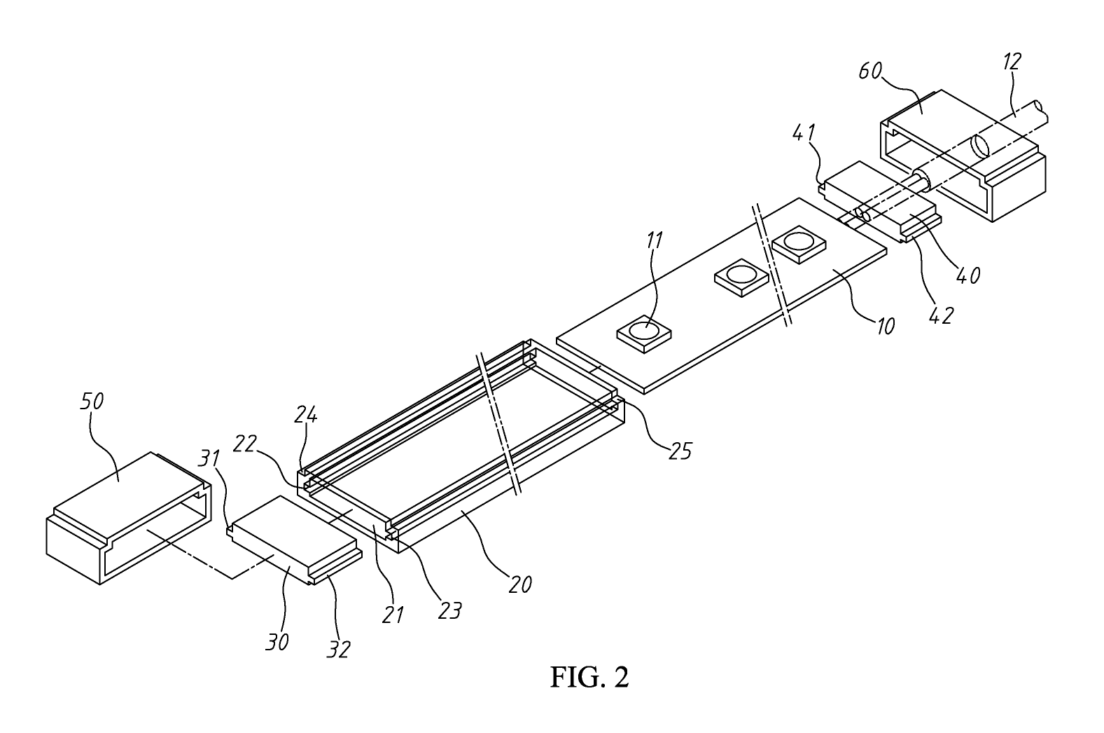

Referring to FIGS. 1 and 2, a LED lamp structure in accordance with the present invention generally is shown. The LED lamp structure comprises a circuit board 10 having a plurality of LEDs (light-emitting diodes) 11 mounted thereon by, for example, but not limited to, surface-mount technology; a power cable 12 extended from the circuit board 10 and electrically connectable to an external power source to obtain the necessary working voltage for the LEDs 11 at the circuit board 10; a housing 20, which is made of a transparent material (for example, transparent plastics) and comprises an accommodation chamber 21 extending through opposing front and rear ends thereof and configured to accommodate the circuit board 10 and its LEDs 11, two longitudinal locating grooves 22;23 bilaterally disposed in the accommodation chamber 21 and configured subject to the wall thickness of the circuit board 10 and at least one, for example, two outside steps 24;25 bilaterally located on the outside wall thereof and extending along the length thereof; two end plugs 30;40 respectively plugged into opposing front and rear ends of the accommodation chamber 21, each end plug 30;40 having two opposing side flanges 31;32 or 41;42 respectively press-fitted into the longitudinal locating grooves 22;23; and two end caps 50;60 respectively capped on the opposing front and rear ends of the housing 20.

Further, the housing 20 can be each of a number of cut pieces obtained from an integral tubular bar of a transparent material subject to a predetermined length that fits the dimension of the circuit board 10. Further, one of the two end plugs 30;40 provides a through hole for the passing of the power cable 12. Further, the two end caps 50;60 have a cross-sectional configuration fitting the cross section of the housing 20, i.e., each end cap 50;60 defines therein two inside steps in the inside wall thereof to fit the outside steps 24;25 of the housing 20. Further, one of the two end caps 50;60 provides a through hole for the passing of the power cable 12.

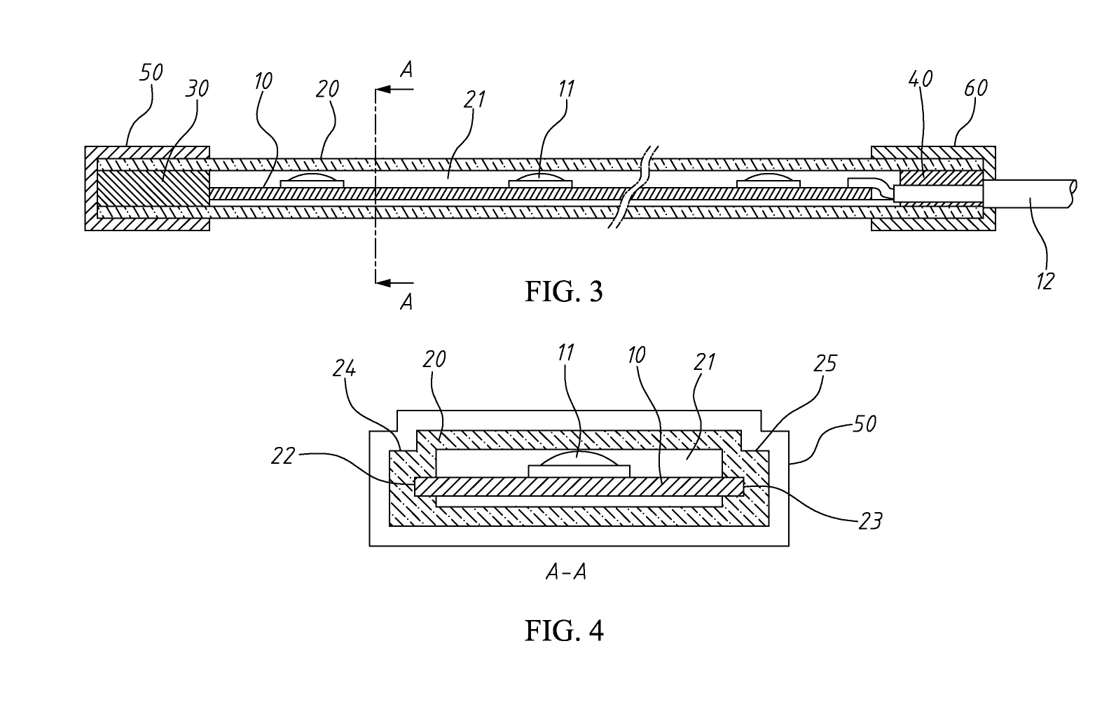

Referring to FIGS. 3 and 4, when assembling the LED lamp structure, insert the circuit board 10 into the longitudinal locating grooves 22;23 in the accommodation chamber 21 of the housing 20, and then press-fit the two end plugs 30;40 into the opposing front and rear ends of the accommodation chamber 21 respectively, and then cap the two end caps 50;60 onto the opposing front and rear ends of the housing 20 respectively.

According to the present invention, the housing of the LED lamp structure is a cut piece obtained from an integral tubular bar of a transparent material subject to a predetermined length. The manufacturer can cut each prepared integral tubular bar into multiple pieces subject to different lengths for making different lengths of LED lamps, saving much the manufacturing costs and steps and meeting watertight safety rules.

Although a particular embodiment of the invention has been described in detail for purposes of illustration, various modifications and enhancements may be made without departing from the spirit and scope of the invention. Accordingly, the invention is not to be limited except as by the appended claims.

1. A LED lamp structure, comprising:
a circuit board comprising a plurality of spaced light-emitting diodes and a power cable electrically connectable to an external power source;
a single-piece housing surrounding said circuit board, said housing comprising an accommodation chamber extending through opposing front and rear ends thereof for accommodating said circuit board and said light-emitting diodes;
two end plugs respectively plugged into the opposing front and rear ends of said single-piece housing, each end plug of said two end plugs having a cross section corresponding to a cross section of said accommodation chamber, one said end plug defining a through hole for the passing of said power cable; and
two end caps respectively encasing the opposing front and rear ends of said single-piece housing, one said end cap defining a through hole for the passing of said power cable;
wherein an end of said single-piece housing and an end of one said end plug engaging a corresponding end cap of the two end caps.

2. The LED lamp structure as claimed in claim 1, wherein said single-piece housing comprises two longitudinal locating grooves bilaterally disposed in said accommodation chamber and configured subject to the board thickness of said circuit board for the positioning of said circuit board.

3. The LED lamp structure as claimed in claim 2, wherein each said end plug comprises two opposing side flanges respectively inserted into said longitudinal locating grooves of said single-piece housing.

4. The LED lamp structure as claimed in claim 1, wherein said single-piece housing comprises at least one step located in an edge thereof and extending along a length thereof, said edge is located at an intersection of a top wall and a side wall of said single-piece housing and extends along the length of said single-piece housing.

5. The LED lamp structure as claimed in claim 2, wherein said single-piece housing comprises at least one step located in an edge thereof and extending along a length thereof, said edge is located at an intersection of a top wall and a side wall of said single-piece housing and extends along the length of said single-piece housing.

6. The LED lamp structure as claimed in claim 3, wherein said single-piece housing comprises at least one step located in an edge thereof and extending along a length thereof, said edge is located at an intersection of a top wall and a side wall of said single-piece housing and extends along the length of said single-piece housing.

7. The LED lamp structure as claimed in claim 4, wherein each said end cap has an interior cross section corresponding to an exterior cross section of the opposing front and rear ends of said single-piece housing.

8. The LED lamp structure as claimed in claim 1, wherein each said end plug of said two end plugs is located in an interior of said corresponding end cap of the two end caps.
